(19) United States
(12) Patent Application Publication
(10) Pub. No.: US 2026/0065002 A1
(43) Pub. Date: Mar. 5, 2026

(54) Coded LED Flicker Information Communication

(71) Applicant: SEMICONDUCTOR COMPONENTS INDUSTRIES, LLC, Scottsdale, AZ (US)

(72) Inventor: Jon Patrick DALEY, Boise, ID (US)

(73) Assignee: SEMICONDUCTOR COMPONENTS INDUSTRIES, LLC, Scottsdale, AZ (US)

(21) Appl. No.: 18/823,529

(22) Filed: Sep. 3, 2024

(51) Int. Cl. G06K 7/10; G06K 7/14

(52) U.S. Cl. CPC G06K 7/10732; G06K 7/1413; G06K 7/1417

(57) ABSTRACT

The technology involves providing illumination via an illumination module, which is perceivable by a person when the illumination module is operating in a first mode. The technology also involves the illumination module emitting a coded pattern when operating in a second mode. This can be done concurrently so that the person cannot perceive the coded pattern. This can involve coordinating a light emitting diode (LED) on/off frequency of the illumination module, along with an image sensor capture rate and exposure time. The coded pattern may be used to complement the information displayed to the person, aid in autonomous operation of a vehicle, identify environmental or other conditions to a computing device, or provide other technical benefits.

### BACKGROUND

Light emitting diodes (LEDs) are used in many applications, including signage, signal lights on vehicles, lighting using LED arrays, etc. Such LED configurations may flicker at a very high frequency that is not perceptible by human vision. Thus, a person's persistence of vision gives the appearance that the LED sign, signal or other device is constantly on. However, image sensors, such as complementary metal-oxide semiconductor (CMOS) sensors, are able to capture images fast enough that the gaps in LED on and off conditions can cause unwanted artifacts in the captured images.

### BRIEF SUMMARY

The technology involves synchronizing or otherwise coordinating the LED on/off frequency and image sensor capture rate and exposure time such that a secondary, coded pattern is detectable by the image sensor while not being perceivable by a person. The technology takes advantage of the fact that a person is able to perceive one type of information from an LED device (or even simple illumination from the LED device), while also using concurrently an image sensor to detect another, supplemental type of information from the LED device. The coded pattern may be used to complement the information displayed to the person, aid in autonomous operation of a vehicle, identify environmental or other conditions to a computing device, etc.

According to one aspect of the technology, an illumination module is provided. It comprises a set of light emitting diodes (LEDs) configured to provide illumination, and a controller operatively coupled to the set of LEDs. The controller is configured to cause the set of LEDs to operate in multiple phases that concurrently (1) provide a coded pattern detectable by an image sensor, and (2) provide illumination perceivable by a person, wherein the coded pattern is not perceivable by the person.

In various examples, the coded pattern may comprise a barcode, a binary code, or a QR code. Alternatively or additionally, the controller may be configured to cause the LEDs to operate in the multiple phases according to a selected duty cycle. For example, the duty cycle may be a 50/50 duty cycle. Alternatively or additionally to any of the above, the coded pattern may be selected to complement user information provided by the set of LEDs that is perceivable by the person.

Alternatively, the image sensor may be part of a client computing device. In this case, the coded pattern includes information that is presentable to the person via the client computing device. Here, the information that is presentable to the person may include information associated with a business or other operating entity, such as a hospital or government entity. 8.

Alternatively, the image sensor may be part of an industrial system. In this case, the coded pattern includes information usable by the industrial system to control or modify operation of the industrial system.

Alternatively, the illumination module may be part of a vehicle. In this case, the set of LEDs comprises one or more of a brake light, a turn signal, headlight or a daytime running light. Here, the coded pattern may be configured to provide information regarding operation of the vehicle to one or more road users.

In one scenario, the illumination module is configured to synchronously provide the coded pattern for detection by the image sensor. In this case, the coded pattern may be employed as a confirmatory feature for operation of the image sensor. Alternatively, in another scenario the illumination module is configured to asynchronously provide the coded pattern for detection by the image sensor.

According to another aspect of the technology, an illumination method is provided which comprises: causing, by a controller operatively coupled to a set of light emitting diodes (LEDs) configured to provide illumination, the set of LEDs to operate in a first phase providing a coded pattern detectable by an image sensor; and causing, by the controller, the set of LEDs to operate in a concurrent second phase providing illumination perceivable by a person, wherein the coded pattern is not perceivable by the person. The controller may cause the LEDs to operate in the first and second phases according to a selected duty cycle.

In one scenario, the coded pattern is selected to complement user information provided by the set of LEDs that is perceivable by the person. In another scenario, the controller causes the LEDs to synchronously provide the coded pattern for detection by the image sensor. In a further scenario, the controller causes the LEDs to asynchronously provide the coded pattern for detection by the image sensor.

In one example, the coded pattern is employed as a confirmatory feature for operation of the image sensor. In another example, the coded pattern is configured to provide information regarding operation of a vehicle to one or more road users.

### BRIEF DESCRIPTION OF THE DRAWINGS

FIGS. 1A-B illustrate an example flicker scenario in view of aspects of the technology.

FIG. 2 illustrates an example of flicker phase states in accordance with aspects of the technology.

FIG. 3 illustrates an exemplary image sensing scenario in accordance with aspects of the technology.

FIG. 4 illustrates an exemplary image sensing scenario in accordance with aspects of the technology.

FIG. 5 illustrates an exemplary imaging system for use with aspects of the technology.

FIG. 6 illustrates an image pixel array and readout assembly for use with aspects of the technology.

FIGS. 7A-C illustrate example LED configurations in accordance with aspects of the technology

FIG. 8 illustrates an example method in accordance with aspects of the technology.

### DETAILED DESCRIPTION

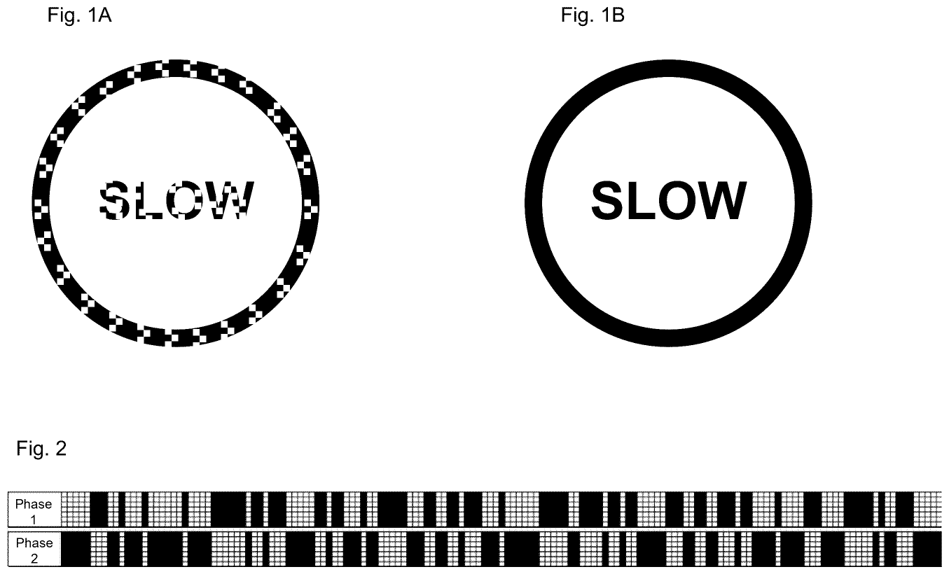

FIGS. 1A-B illustrate an example LED flicker scenario. In particular, FIG. 1A shows a message being presented using, e.g., an array of LEDs. By way of example, the message (here, “SLOW”) may be from a sign presenting information to one or more people. This could be a sign along a roadway, on a storefront, in a warehouse or office, etc. As shown in FIG. 1A, due to the flicker rate of the LED array, an image sensor such as a CMOS sensor may capture an image of the message that includes unwanted artifacts. In contrast, FIG. 1B shows the message as it would be seen by a human eye (perceived by a person), or an image sensor that implements LED flicker mitigation (LFM) to correct for the unwanted artifacts.

However, instead of undesired artifacts, the LED flickering could be configured to hold a pattern and flicker between complimentary “phase 1” and “phase 2” states to generate a coded pattern. Illustrated in FIG. 2 are two flicker phase states as a barcode. In phase 1, certain pixels are “on” as shown in white), while other pixels are “off” as shown in black. In phase 2, the pixel states are flipped. The barcode can convey any type of code/message desired. Moreover, instead of a barcode, the code/message could be in another format, such as binary code, QR code, or any other code detectable by an image sensor.

According to one scenario, the on/off duty cycle can be 50/50 for each phase. However, in other scenarios, the LED(s) may remain on longer for one of the phases than the other. By way of example only, the on/off split may be 60/40, 70/30, or some other duty cycle between the phases. Moreover, there may be more than 2 phases with complementary or other different information being conveyed in each phase (e.g., 3, 4 or more phases). Regardless of the number of phases or the duty cycle, the coded pattern(s) are able to be concurrently presented while the illumination (e.g., for signage or the like) is concurrently perceivable by a person. Thus, concurrent operation encompasses the two or more phases of operation.

### Example Scenarios

As noted above, the coded pattern may be complementary to the information displayed to the person. For instance, this could be used to aid in autonomous operation of a vehicle, identify environmental or other conditions to a computing device, etc.

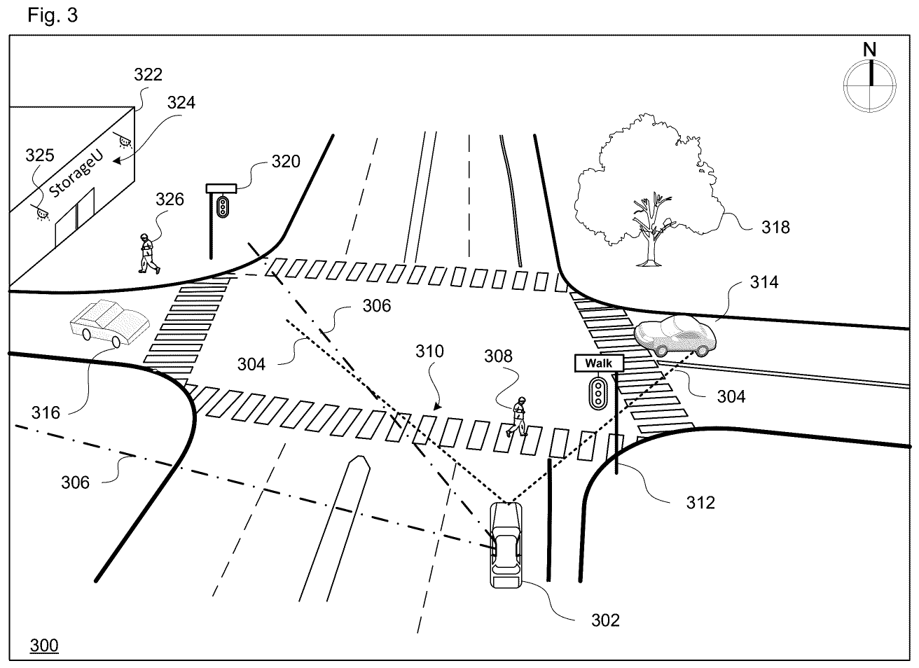

By way of example, FIG. 3 illustrates an exemplary image sensing scenario 300, where one or more image sensors are part of a perception system of a vehicle 302. The perception system may be configured to obtain imagery from one or more fields of view of the vehicle, such as a front-facing field of view indicated by dotted lines 304, or a side facing field of view as indicated by dash-dot lines 306. Note that in this example, the fields of view 304 and 306 overlap. As shown, there are a number of objects in the nearby external environment of the vehicle 302. Those objects include pedestrian 308, crosswalk 310, a traffic light 312 on the southeast corner of the intersection, vehicle 314 heading westbound, vehicle 316 heading eastbound, tree 318, a traffic light 320 on the northwest corner, a store 322 having a sign 324 and a light 325, and another pedestrian 326 near the store 322.

In this scenario, the traffic light 312 may include a sign that presents information both to the pedestrian 308 in the crosswalk 310, as well as to vehicle 302. For instance, as shown one set of information is directed at the pedestrian 308, indicating “Walk”. In addition to this, information may also be directed at the vehicle 302 via a coded pattern that may not be perceived by the pedestrian 308. As an example only, the coded pattern may indicate that the vehicle 302 has a red light, that the “Walk” sign is on, that there are one or more pedestrians or other road users (e.g., cyclists, wheelchairs, etc.) in the crosswalk, and/or other information associated with the state of the intersection. This coded pattern can be detected by one or more sensors of the vehicle 302 that have the front-facing field of view 304.

Also in the scenario 300, the sign 324 may be employed to present information not only to the pedestrian 326, but to a computing device (e.g., a mobile phone, smartwatch, head-mounted display, etc.) of that person. By way of example, the sign 324 may indicate the name of the store to the person (here, “StorageU”). In addition, the sign 324 may also emit a coded pattern, which is detectable by the person's computing device. This coded pattern may include information about specials or other items the store currently has in stock, sale, coupon or other advertisement information, direction, or any other information which may be presented to the pedestrian 326 via a user interface of the device (e.g., displayed via a graphical user interface in a browser window). Moreover, the light 325 may both provide illumination to pedestrians while also providing coded patterns detectable by computing devices, for instance in a manner similar to that of the sign 324. By way of example, the coded pattern here may include directions to the store, a map or other layout, information about store hours, or other information about the business.

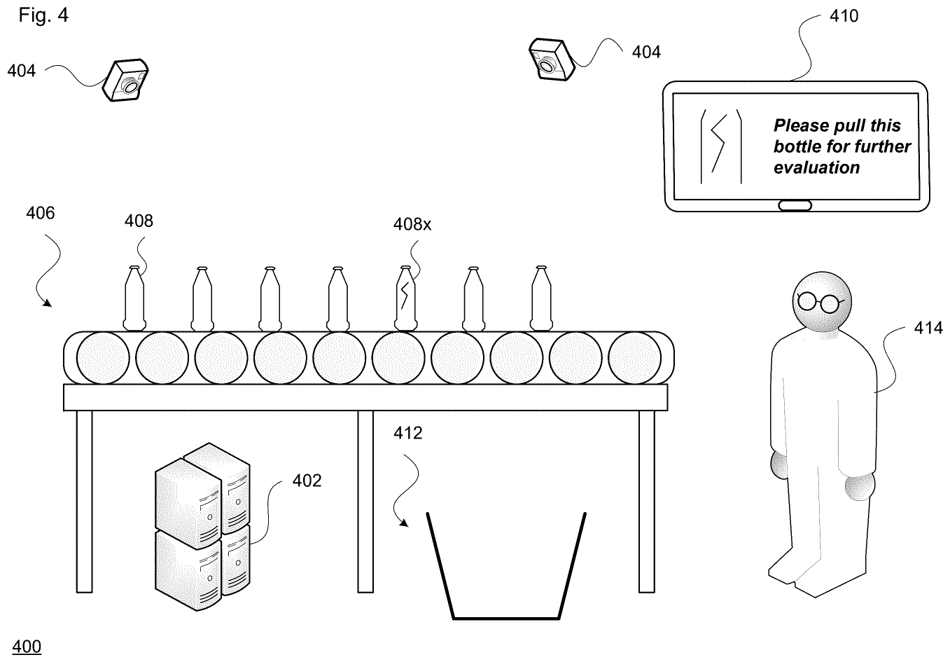

Additional exemplary scenarios include where the image sensor(s) are part of an imaging/detection system for machine vision imaging, inspection, surveillance/security, medical imaging, or other applications. FIG. 4 illustrates one such machine vision/inspection scenario.

In particular, FIG. 4 illustrates a scenario 400, where a set of image sensors are part of an automated inspection system, although it may be part of any other type of industrial or commercial system, such as a manufacturing system, packaging system, food preparation system, etc. In particular, the inspection system in this example includes a processing system 402 operatively coupled to image sensors 404. The image sensors 404 are configured to obtain imagery along an inspection line 406 (e.g., a manufacturing or an assembly line) or other inspection setup. As shown here, a number of items, such as bottles 408, move along the inspection line 406. A display 410 may present imagery captured by the image sensors 404, along with other information for an inspector. One of the items, in particular bottle 408x, appears to have a crack or other defect, as displayed on display 410. As part of an automated inspection process, this defective item may be discarded into bin 412. In other situations, any defective items may be flagged or otherwise identified for further testing or repair.

In this scenario, the display 410 may present information to a user 414 in addition to the imagery being displayed from the inspection line 406. In particular, the information may provide guidance on what to do with the bottle 408x, e.g., “Please pull this bottle for further evaluation”. The display 410 may also provide information to at least one of the image sensors 404 via a coded pattern. This information may include, e.g., a speed of the inspection line 406, temperature, humidity, light level or other ambient condition information, equipment status, equipment error codes, or other data that may be used by the processing system 402.

The processing system may use the coded information to perform one or more tasks. For instance, the processing system may control operation of the inspection system such as to increase or decrease the speed of the inspection line. Alternatively or additionally, it may modify one or more ambient conditions, such as decreasing (or increasing) the temperature and/or humidity, increasing (or decreasing) the light level in the room, etc. It may also update a database with information based on the coded pattern, generate reports, print labels, or otherwise use the coded pattern to enhance the operation of the inspection system.

In yet another scenario, the processing system may be used in a residential or concierge-type situation. For instance, the coded pattern(s) may be used to cause a robotic or otherwise autonomous vacuum cleaner to clean specific parts of a residence, vacation rental or hotel room at a specific time (e.g., when people are leaving the room). Alternatively or additionally, the coded pattern(s) may instruct a smart appliance, such as a washing machine, dryer, thermostat, oven, smart television or music player, etc., to begin, modify or cease operation.

### Example Imaging System

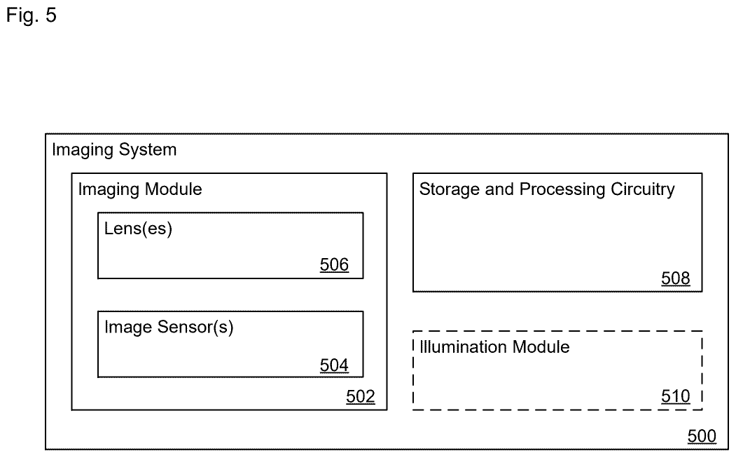

FIG. 5 is a block diagram of an exemplary imaging system 500 for use with aspects of the technology, such as an electronic device that employs sensor circuitry (also referred to as a sensor module) to capture imagery. Imaging system 500 may comprise or be part of a still or video camera, a webcam, a mobile phone, a laptop or tablet computer, a video surveillance system, a vehicle imaging system such as for a car or a truck, a video game system with imaging capabilities, an augmented reality (AR) and/or virtual reality (VR) system, an unmanned aerial vehicle system (such as a drone), a commercial or industrial system, etc. Camera (or imaging) module 502 is configured to convert incoming/received light into digital image data. The imaging module 502 includes one or more image sensors (or sensor modules) 504. While the imaging module 502 may be configured for optical imaging, in other aspects the system may be configured for other imaging approaches, such as lidar imaging (e.g., in the near-infrared spectrum), etc.

During an image capture process, light from a scene is focused onto the image sensor(s) 504 by one or more corresponding lenses 506. This may include light generated by one or more LEDs of a sign or other device. Image sensors 504 may include circuitry for generating analog pixel image signals and circuitry for converting those image signals into corresponding digital image data. The digital image data may be provided to storage and processing circuitry 508.

Storage and processing circuitry 508 may include, e.g., one or more integrated circuits (ICs), such as image processing circuits, microprocessors, storage devices such as random-access memory (RAM) and/or non-volatile memory (NVM), etc. This circuitry may be implemented using components that are separate from imaging module 502 or that may form part of imaging module 502. When storage and processing circuitry 508 is implemented on different ICs than those implementing imaging module 502, the ICs with circuitry 508 may be stacked or otherwise packaged with the ICs for imaging module 502.

Image data that has been captured by imaging module 502 may be processed and stored using processing circuitry 508 (e.g., using an image processing engine of processing circuitry 508, using an imaging mode selection engine on processing circuitry 508, etc.). Processed image data may be provided to external equipment such as a computer, a vehicle control system, a medical imaging system, an external display, or other devices using a wired or wireless communications path coupled to processing circuitry 508 (not shown).

In the example of FIG. 5 as shown in the dashed box, imaging module 502 may include an illumination module 510, which can be configured to emit light for illuminating objects in an image scene. Image sensor(s) 504 may be configured to gather reflected versions of the emitted light and to generate image information for the scene. By way of example only, such image information may include depth or distance information for one or more objects, a depth or distance map of the image scene, an image of the image scene, etc.

The illumination module 510, such as a light emitter controlled by driver circuitry (not shown), may emit light having any suitable characteristic(s). This can include any suitable waveform(s), peak amplitude or power, periodicity or frequency or phases, pulses of light, light with a modulated amplitude and a modulation frequency, etc. The emitted light may be in the infrared (IR) such as SWIR and/or optical bands, and may be generated by one or more LEDs or a laser configured to emit one or more light pulses, such as in a light pulse train. The emitted light may reach one or more objects in an image scene and reflect off of such objects, returning to the camera module 502 as reflected light. Objects may include any suitable objects, whether fixed or mobile. By way of example only, in a driving scene for a vehicle operating in an autonomous (or manual) driving mode (see FIG. 3), objects may include signage, street light, driving or bike lanes, curbs or sidewalks, other road users (e.g., other vehicles, bicyclists or pedestrians), trees or shrubbery, etc.

Reflected light may be received at the image sensor 504 (e.g., at one or more active image pixels, at one or more photosensitive elements in the active image pixels, etc.). Driver circuitry and/or control circuitry may control the pixels to generate one or more image frames based on the reflected light, such as by providing control signals coupled to transistors or other actuated elements (e.g., switching elements) in the pixels. In particular, based on the received control signals from the driver circuitry and/or control circuitry, the pixels may generate different portions of charge in response to reflected light (e.g., during an integration or exposure time period), may perform one or more readout operations on the generated portions of charge (e.g., during a readout time period), or may perform other operations during other time periods.

Processing circuitry in imaging module 502 or processing circuitry in the imaging system 500) may control illumination module 510 and know the characteristics of the emitted light signal. The processing circuitry may then control the image sensor(s) 504 to generate image signals for one or multiple image frames, which are indicative of the characteristics of the reflected light signal. The system may process (e.g., compare and correlate) the generated image signals for these image frames to the reflected light and to emitted light to determine a phase difference and/or time of flight information.

The processing circuitry may control the image sensor capture rate and exposure time such that one or more coded patterns are detectable by the image sensor (which may not be perceived by a person). These coded patterns may be decoded by the processing circuitry of the imaging system, or may be sent to another processing device to be decoded and/or acted on.

### Example Pixel Array and Readout Assembly

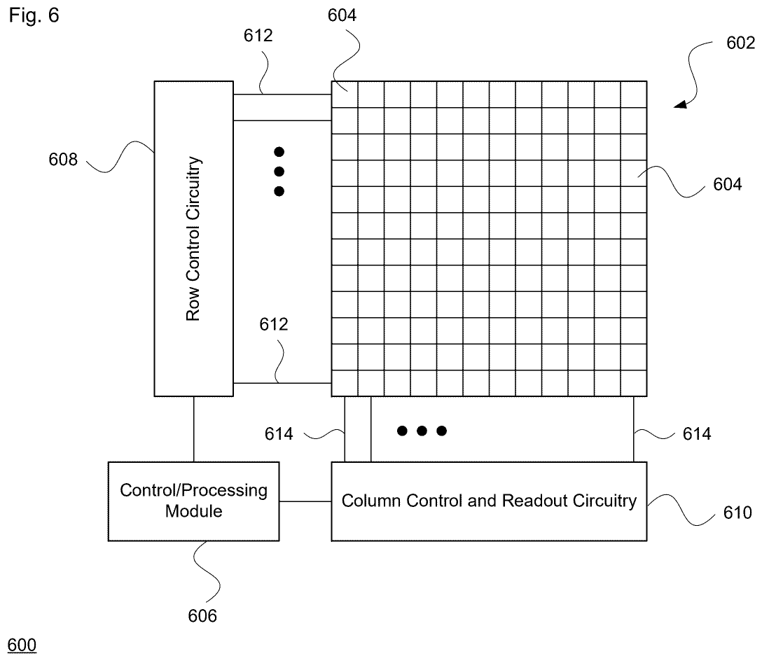

FIG. 6 is a diagram of an illustrative configuration for an image pixel array and readout assembly 600 for the image sensor 504 of FIG. 5. This may be a CMOS-type configuration. As shown in FIG. 6, the assembly 600 includes a pixel array 602 containing sensor pixels 604 arranged in rows and columns, along with control and processing circuitry in module 606. The array 602 may contain, for example, tens, hundreds, or thousands of rows and columns of sensor pixels 604. Module 606 may be coupled to row control circuitry 608 (sometimes referred to as row driver circuitry or pixel driver circuitry) and column control and readout circuitry 610 (sometimes referred to as column readout circuitry or column control circuitry, readout circuitry, or column decoder circuitry). Control module 606 may receive (row) addresses from row control circuitry 608 and supply corresponding (row) control signals such as reset, anti-blooming, row select (or pixel select), modulation, storage, charge transfer, readout, sample-and-hold, and/or store control signals to pixels 604 over (row) control paths 612.

One or more lines such as column lines 614 may be coupled to each column of pixels 604 in array 602. Column lines 614 may be used for reading out image signals from pixels 604 and for supplying bias signals (e.g., bias currents or bias voltages) to pixels 604. The column control and readout circuitry 610 may receive image signals (e.g., analog pixel values generated by pixels 604) over lines 614. This circuitry 610 may include memory circuitry for storing calibration signals (e.g., reset level signals, reference level signals) and/or image signals (e.g., image level signals) read out from the array 602, amplifier circuitry or a multiplier circuit, analog to digital conversion (ADC) circuitry, bias circuitry, latch circuitry for selectively enabling or disabling the portions (columns) of the circuitry 610, or other circuitry that is coupled to one or more pixels in array 602 for operating pixels 604 and for reading out image signals from pixels 604. ADC circuitry in the circuitry 610 may convert analog pixel values received from array 602 into corresponding digital pixel values (sometimes referred to as digital image data or digital pixel data). The circuitry 610 may supply digital pixel data to control/processing module 606 for pixels 604 (e.g., in one or more pixel columns).

The pixel array 602 may also be provided with a filter array having multiple (color) filter elements each corresponding to a respective pixel, which allows a single image sensor to sample light of different colors or sets of wavelengths. In general, filter elements of any desired color and/or wavelength (e.g., optical or infrared wavelengths) and in any desired pattern may be formed over any desired number of image pixels 604. By way of example, for time-of-flight sensing using an illumination source (e.g., in illumination module 510 in FIG. 5), the pixel array 602 may be provided with a correspond filter array that passes light having colors and/or frequencies emitted from the illumination source.

The image sensors 504 of imaging module 502 (FIG. 1) may include one or more arrays 602 of image pixels 604. The image pixels 604 may be formed in a semiconductor substrate using complementary metal-oxide-semiconductor (CMOS) technology. Alternatively, the pixels 604 may be formed using charge-coupled device (CCD) technology, or any other suitable photosensitive device technology. Image pixels 604 may be frontside illumination (FSI) image pixels or backside illumination (BSI) image pixels. Moreover, the array 602 may include pixels 604 of different types such as active pixels, optically shielded pixels, reference pixels, etc. If desired, the image sensor(s) may include an integrated circuit package or other structure in which multiple integrated circuit substrate layers (e.g., from multiple wafers) or chips are vertically stacked or otherwise arranged with respect to each other. According to aspects of the technology, the pixels may comprise an array of silicon photomultiplier (SiPM) microcells or another type of photomultiplier such as a single-photon avalanche photodiode (SPAD).

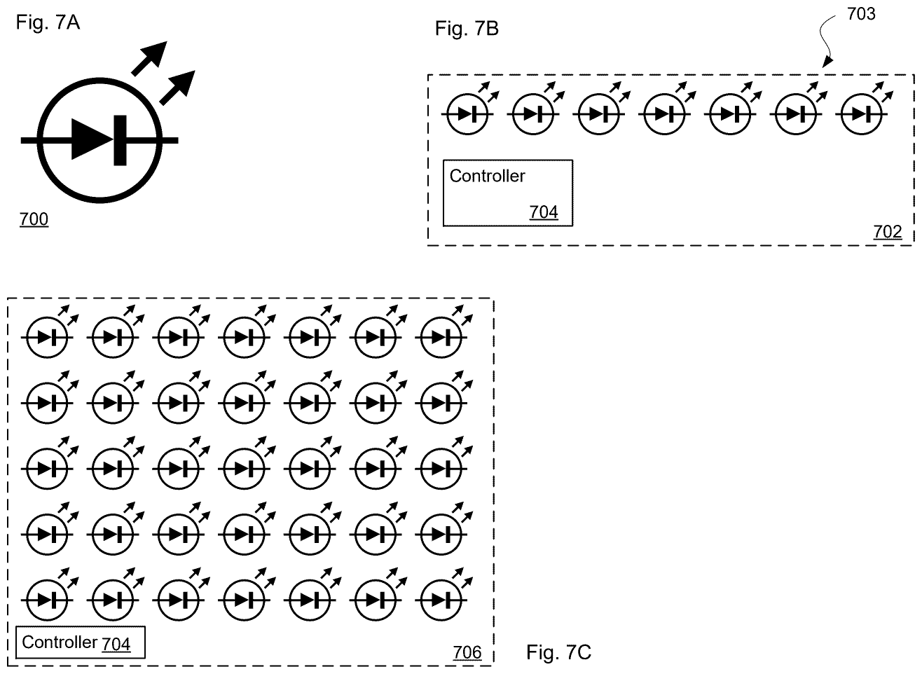

FIG. 7A presents a representation of an LED 700. In accordance with the technology, one or more LEDs may be employed for illumination, communication or signage that is perceivable by a person. FIG. 7B illustrates an example illumination module 702 including a strip of LEDs 703 that may be used, e.g., for illumination. As shown, the illumination module 702 may include a controller 704. The controller 704 may cause the LEDs of the strip to change between two (or more) flicker phase states (phases), for instance by controlling the flow of current to each LED during a given phase to cause that LED to be either on (emitting illumination) or off (not emitting illumination).

In one scenario, the LED strip may illuminate a walkway or pathway, e.g., in a movie theater, exhibition hall, museum, plane, bus, etc. for people walking, while also creating a coded pattern that may be detected by users' device such as a mobile phone, wearable computing device such as a smartwatch or head-mounted display, or the like. In this scenario, the coded pattern may be used to indicate various information to the devices, including a seating row, nearby exhibits in a museum or exhibition hall, time until a show or presentation will start, etc.

In another scenario, the strip 703 may be a set of LEDs of a vehicle, such as may be used in a brake light, turn signal, daytime running light, headlight, etc. The controller in this case may be part of an illumination system of the vehicle, or other processing system of the vehicle such as an onboard control system. Here, in addition to such lights being visible to drivers or other road users (e.g., pedestrians, bicyclists, etc.), the coded information detectable by the CMOS or other image sensor could be used to inform another vehicle, such as one operating in an autonomous driving mode, how hard the vehicle is braking, when the vehicle will be changing lanes or making a turn, provide traction/slippage or other road condition information, indicate information about other nearby objects that have been detected, and/or other types of information.

In a further configuration as shown in FIG. 7C, the LEDs may be arranged in an array 706 of any size or shape. As with the strip 704, the array 706 may include the controller 704 to cause the LEDs of the array to change between two (or more) flicker phase states, thereby generating one or more coded patterns. Thus, in one scenario the array 706 may be used as signage for people while also providing other information to a computing device or vehicle, such as described above with regard to FIGS. 3 and 4.

In many situations, including those discussed above, the dual operation of the LED(s) may be performed asynchronously with respect to image capture by an image sensor. Alternatively, in other situations, there may be synchronous communication between the LED(s) and the image sensor. This may occur when both devices use or share a common protocol.

In another synchronous communication situation, the LED(s) may be part of an illumination module of an imaging system. In this case, the LEDs could transmit the coded information from the same device that captures imagery. This may be performed as a confirmatory feature to either ensure the that the imaging device is operating properly, or is able to detect something in its field of view. Moreover, the imaging system may be able to adjust and/or synchronize the image frame rate or image collection frequency to some multiple or fraction of the LED flicker per an emitted coded pattern to optimize information capture by the imaging device.

In yet another situation, the LEDs may be controlled to alternative between the phases upon detection that either a person or a computing device (or image sensor) is present in the environment (e.g., with a threshold distance of the LEDs). Alternatively or additionally, the phase with the coded pattern may be initiated or otherwise occur when there is new or updated information to convey to the computing device (or image sensor). For instance, in the scenario of FIG. 3, if the person 326 comes within 50 meters of the store 322, or it is determined that a computing device is present within that range (e.g., based on received signal strength from a transmitter of the computing device or GPS information associated with the device), then the controller 704 may cause a selected coded pattern to be transmitted either by the sign 324 or the light 325.

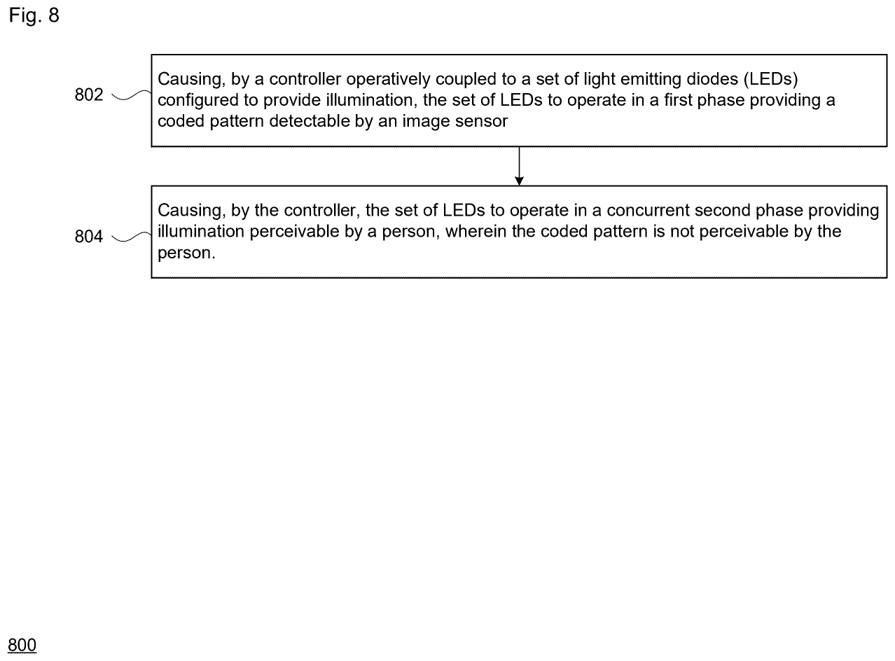

FIG. 8 illustrates an illumination method 800. At block 802, the method includes causing, by a controller operatively coupled to a set of light emitting diodes (LEDs) configured to provide illumination, the set of LEDs to operate in a first phase providing a coded pattern detectable by an image sensor. And at block 802, the method includes causing, by the controller, the set of LEDs to operate in a concurrent second phase providing illumination perceivable by a person, wherein the coded pattern is not perceivable by the person.

Although the technology herein has been described with reference to particular embodiments/configurations, it is to be understood that these are merely illustrative of the principles and applications of the present technology. It is therefore to be understood that numerous modifications may be made to the illustrative embodiments and that other arrangements may be devised without departing from the spirit and scope of the present technology as defined by the appended claims. By way of example only, components that are illustrated as being arranged in series may have a complementary configuration in parallel; similarly, components that are illustrated as being arranged in parallel may have a complementary configuration in series.

1. An illumination module, comprising:
a set of light emitting diodes (LEDs) configured to provide illumination; and
a controller operatively coupled to the set of LEDs, the controller being configured to cause the set of LEDs to operate in multiple phases that concurrently (1) provide a coded pattern detectable by an image sensor, and (2) provide illumination perceivable by a person, wherein the coded pattern is not perceivable by the person.

2. The illumination module of claim 1, wherein the coded pattern comprises one of a barcode, a binary code, or a QR code.

3. The illumination module of claim 1, wherein the controller is configured to cause the LEDs to operate in the multiple phases according to a selected duty cycle.

4. The illumination module of claim 3, wherein the duty cycle is a 50/50 duty cycle.

5. The illumination module of claim 1, wherein the coded pattern is selected to complement user information provided by the set of LEDs that is perceivable by the person.

6. The illumination module of claim 1, wherein:
the image sensor is part of a client computing device; and
the coded pattern includes information that is presentable to the person via the client computing device.

7. The illumination module of claim 6, wherein the information that is presentable to the person includes information associated with a business.

8. The illumination module of claim 1, wherein:
the image sensor is part of an industrial system; and
the coded pattern includes information usable by the industrial system to control or modify operation of the industrial system.

9. The illumination module of claim 1, wherein the illumination module is part of a vehicle, and the set of LEDs comprises one or more of a brake light, a turn signal, headlight or a daytime running light.

10. The illumination module of claim 9, wherein the coded pattern is configured to provide information regarding operation of the vehicle to one or more road users.

11. The illumination module of claim 1, wherein the illumination module is configured to synchronously provide the coded pattern for detection by the image sensor.

12. The illumination module of claim 11, wherein the coded pattern is employed as a confirmatory feature for operation of the image sensor.

13. The illumination module of claim 1, wherein the illumination module is configured to asynchronously provide the coded pattern for detection by the image sensor.

14. An illumination method, comprising:
causing, by a controller operatively coupled to a set of light emitting diodes (LEDs) configured to provide illumination, the set of LEDs to operate in a first phase providing a coded pattern detectable by an image sensor; and
causing, by the controller, the set of LEDs to operate in a concurrent second phase providing illumination perceivable by a person, wherein the coded pattern is not perceivable by the person.

15. The illumination method of claim 14, wherein the controller causes the LEDs to operate in the first and second phases according to a selected duty cycle.

16. The illumination method of claim 14, wherein the coded pattern is selected to complement user information provided by the set of LEDs that is perceivable by the person.

17. The illumination method of claim 14, wherein the controller causes the LEDs to synchronously provide the coded pattern for detection by the image sensor.

18. The illumination method of claim 14, wherein the controller causes the LEDs to asynchronously provide the coded pattern for detection by the image sensor.

19. The illumination method of claim 14, wherein the coded pattern is employed as a confirmatory feature for operation of the image sensor.

20. The illumination method of claim 14, wherein the coded pattern is configured to provide information regarding operation of a vehicle to one or more road users.
